(19) United States
(12) Patent Application Publication
(10) Pub. No.: US 2007/0283326 A1
(43) Pub. Date: Dec. 6, 2007

(54) System for Defining and Evaluating Target Thresholds Against Performance Metrics

(76) Inventors: Scott M. Consolatti, Raleigh, NC (US); Tong L. Li, Cary, NC (US); Steven M. Miller, Cary, NC (US); Glen E. Salmon, Amesbury, MA (US)

Correspondence Address: HAMILTON & TERRILE, LLP;IBM RSW, P.O. BOX 203518, AUSTIN, TX, 78720, US

(21) Appl. No.: 11/421,623

(22) Filed: Jun. 1, 2006

(51) Int. Cl. G06F 9/44

(52) U.S. Cl. 717/124

(57) ABSTRACT

A method, system and computer-usable medium for setting performance milestones and monitoring their achievement toward a target goal through a graphical user interface. Intermediate performance milestone values are edited by applying configuration data that operate with performance algorithms to more accurately define expected performance over a predetermined time period. The system provides users with rules, policies, and/or constraints, which define and bound dependencies associated with intermediate performance milestones, which in turn can be automatically adjusted to accommodate various users. One or more graphical depictions show boundary information that define movement limits of intermediate points, which can be set in either direction based on dynamic evaluation of existing points and their associated rules, policies, and constraints.

### BACKGROUND OF THE INVENTION

1. Field of the Invention

The present invention relates in general to the field of computers and similar technologies, and in particular to software utilized in this field. Still more particularly, the present invention relates to monitoring performance against predetermined success criteria.

2. Description of the Related Art

Success is typically characterized by using Boolean determinations to compare performance against one or more target goals. Yet performance evaluation often requires characterizations that are relative or indicate a trend, such as overachieving, achieving, marginal, declining, regressing, poor, etc. While it is common to visualize these characterizations using a traffic light metaphor where performance is indicated by green, yellow, or red status, defining target and threshold performance values and then indicating the status of these targets and values can present challenges. Generally, the simplest approach is to define a target value and one or more threshold performance values. However, while a single target value may define the eventual goal, a single target does not facilitate evaluating interim performance over a predetermined period of time.

For example, an annual sales objective may be set at $100 million , with a lower threshold value of $90 million indicating marginal performance and an upper threshold value of $125 million indicating overachievement. In this example, the target goal of $100 million is set to be achieved by the end of the fiscal year, with sales performance and status evaluations being performed at predetermined times throughout the year. A simple solution to establishing performance threshold points for intermediate months is to use interpolation. For example, if the performance objective is $0 at the beginning of the fiscal year and $100 million at the end of the year, then revenue attainment of $50 million at the end of 6 months would be considered achievement, attainment of $45 million would be considered marginal, and attainment of $62.5 million would be considered overachievement.

In view of the foregoing, a more detailed view of target objectives and performance thresholds is desirable to allow support for any number of intermediate targets and thresholds.

### SUMMARY OF THE INVENTION

The present invention includes, but is not limited to, a method, apparatus and computer-usable medium for setting performance milestones and monitoring their achievement toward a target goal through a graphical user interface (GUI). Intermediate performance milestone values may be edited through the GUI by applying configuration data that operate with performance algorithms to more accurately define expected performance over a predetermined time period. The system provides users with rules, policies, and constraints, which define and bound dependencies associated with intermediate performance milestones, which in turn can be automatically adjusted to accommodate various users. One or more graphical depictions show boundary information that defines movement limits of intermediate points within the graph. Movement limits of predetermined intermediate points can be set in either direction based on dynamic evaluation of existing points and their associated rules, policies, and constraints.

Performance algorithms accept a measurement value with a corresponding time index to determine the corresponding target and performance thresholds for that same time index and then formulate a performance status based on the relationship of the measurement to the computed target and performance thresholds. Configuration data includes, but is not limited to, saved data corresponding to ultimate targets and performance thresholds, zero or more intermediate milestone targets and milestone thresholds, and associated rules, policies and/or constraints.

The combination of an ultimate target and one or more performance thresholds, along with intermediate milestone targets and performance thresholds is referred to as a schedule, which can likewise be saved as configuration data and accessed as needed. The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary client computer in which the present invention may be implemented;

FIG. 2 illustrates an exemplary server from which software for executing the present invention may be deployed and/or implemented for the benefit of a user of the client computer shown in FIG. 1;

FIG. 3 shows a generalized block diagram of a performance monitor as implemented in accordance with an embodiment of the present invention;

FIGS. 4a-d show graphical depictions generated by the performance monitors to set performance milestones and monitor their achievement toward a target goal over a predetermined period of time;

FIGS. 5a-c show graphical depictions generated by the performance monitors using an example projection algorithm to set performance milestones and monitor their achievement toward a target goal over a predetermined period of time.

FIGS. 6a-b show a flow-chart of steps taken to deploy software capable of executing the steps shown and described in FIGS. 4a-d;

FIGS. 7a-c show a flow-chart of steps taken to deploy in a Virtual Private Network (VPN) software that is capable of executing the steps shown and described in FIGS. 4a-d;

FIGS. 8a-b show a flow-chart showing steps taken to integrate into a computer system software that is capable of executing the steps shown and described in FIGS. 4a-d; and

FIGS. 9a-b show a flow-chart showing steps taken to execute the steps shown and described in FIGS. 4a-d using an on-demand service provider.

### DETAILED DESCRIPTION

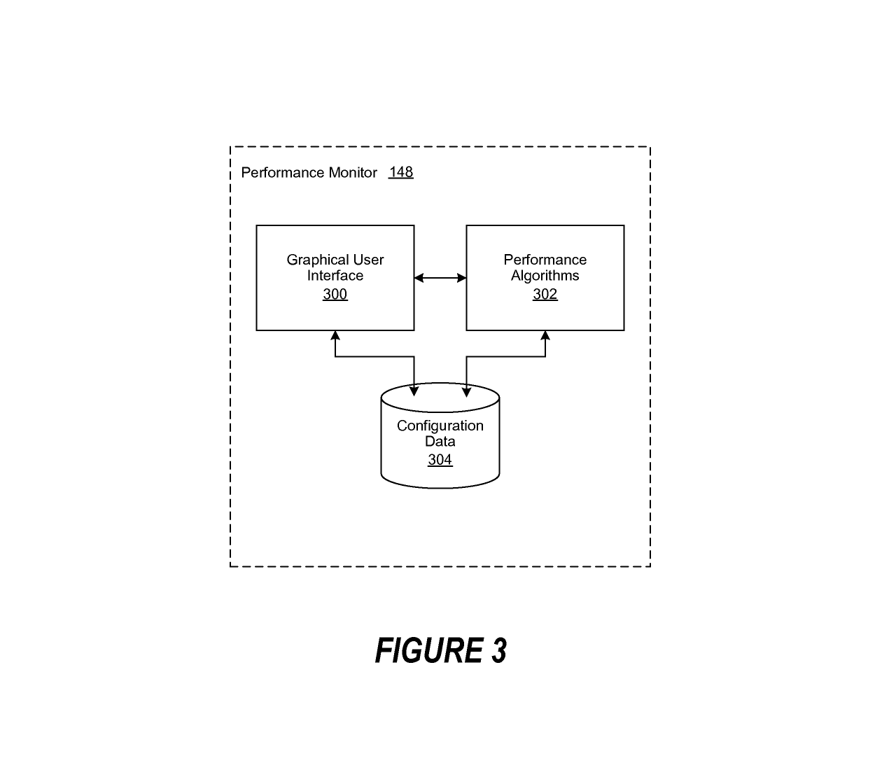

With reference now to the figures, and in particular to FIG. 3, there is depicted a method, apparatus and computer-usable medium for a performance monitor operable to setting performance milestones and monitoring their achievement toward a target goal over a predetermined period of time through one or more graphical depictions.

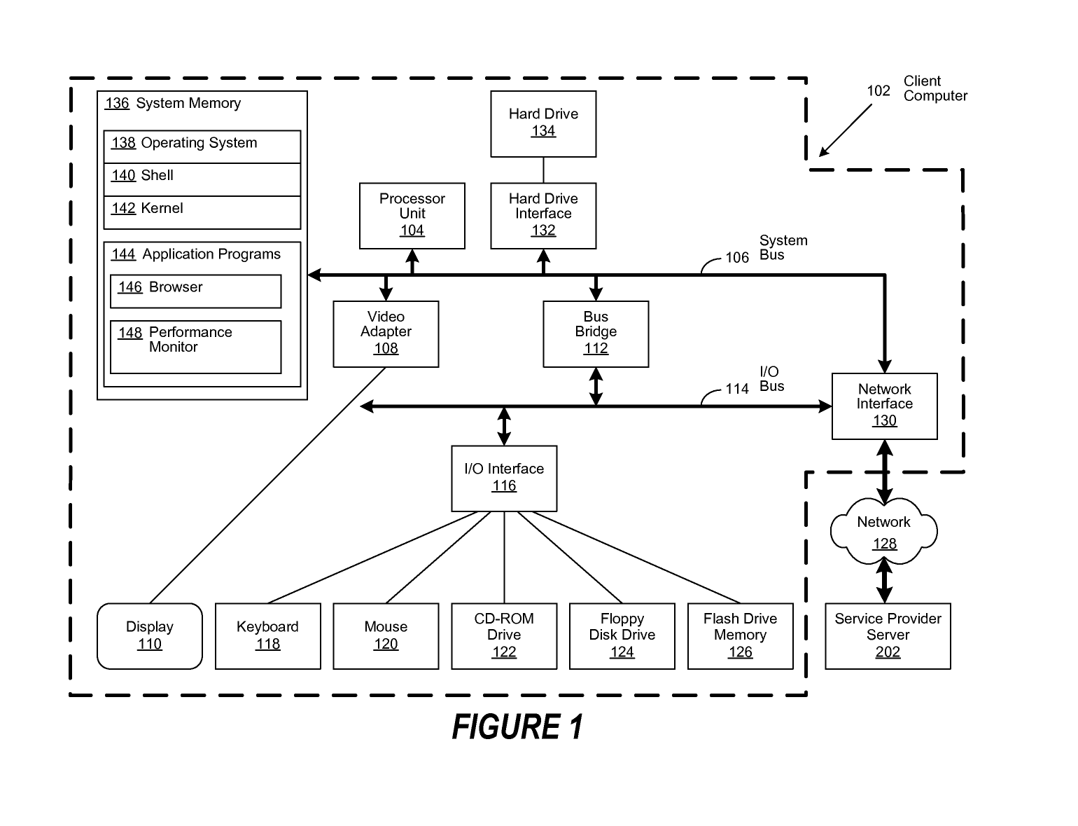

With reference now to FIG. 1, there is depicted a block diagram of an exemplary client computer 102, in which the present invention may be utilized. Client computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk—Read Only Memory (CD-ROM) drive 122, a floppy disk drive 124, and a flash drive memory 126. The format of the ports connected to I/O interface 416 may be any known to those skilled in the art of computer architecture, including but not limited to Universal Serial Bus (USB) ports.

Client computer 102 is able to communicate with a service provider server 202 via a network 128 using a network interface 130, which is coupled to system bus 106. Network 128 may be an external network such as the Internet, or an internal network such as an Ethernet or a Virtual Private Network (VPN). Using network 128, client computer 102 is able to use the present invention to access service provider server 202.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 202.

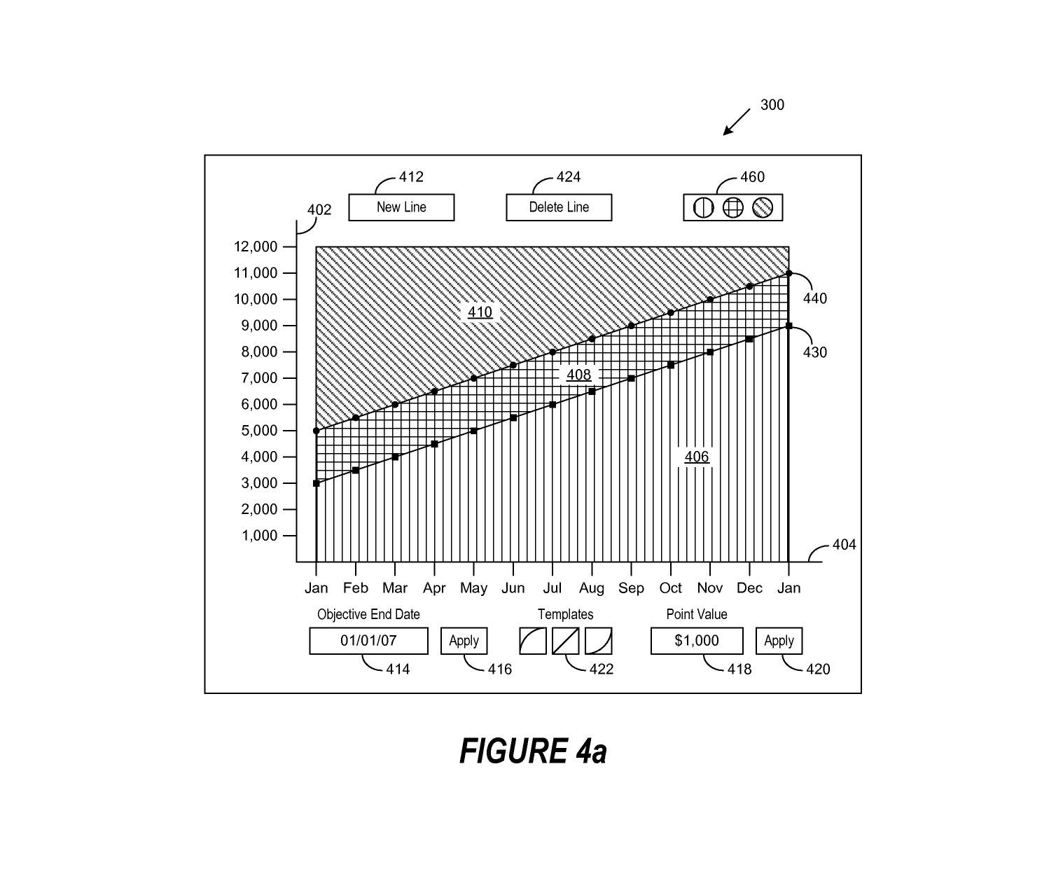

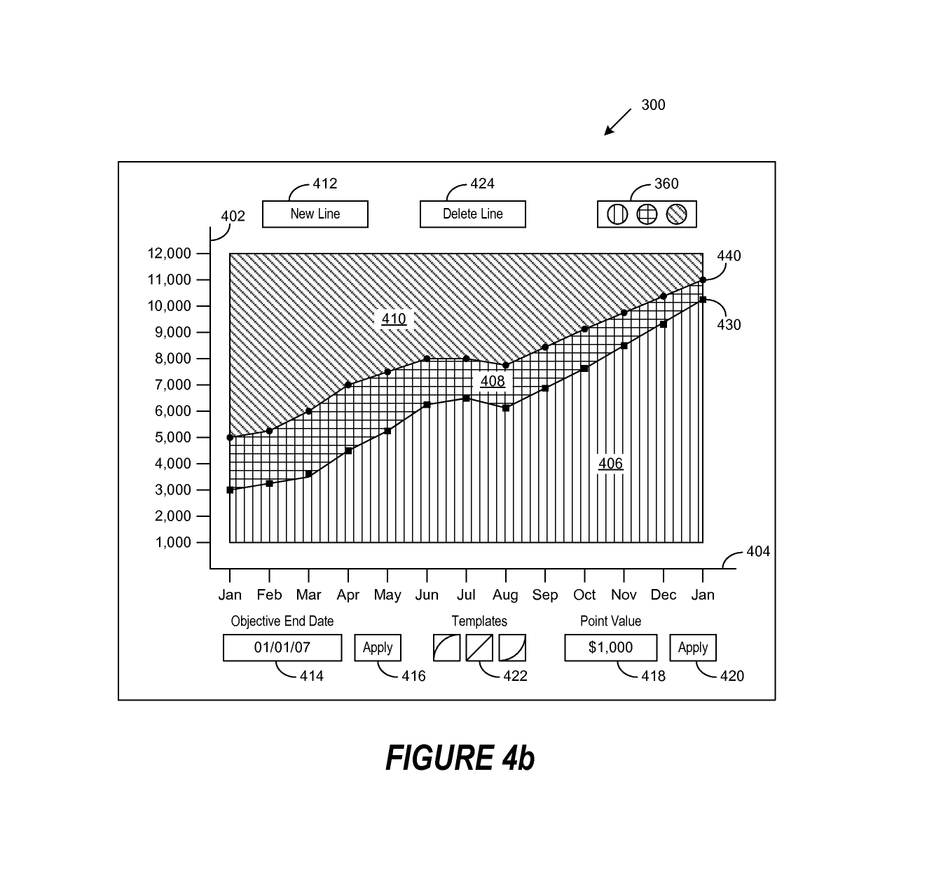

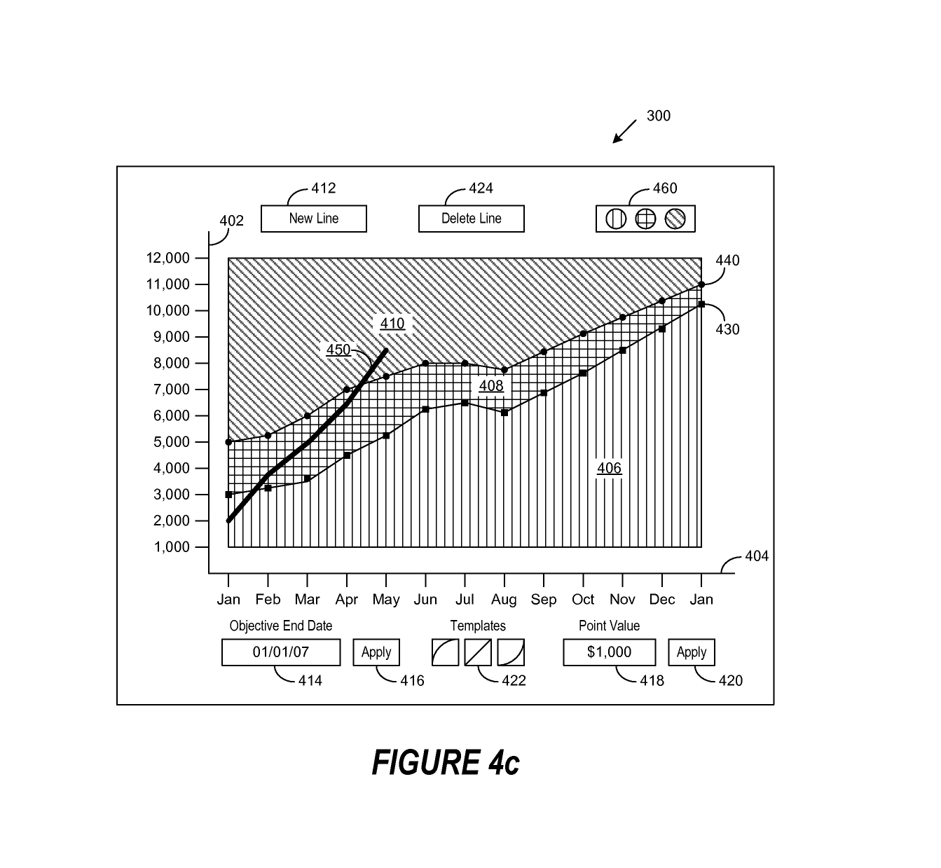

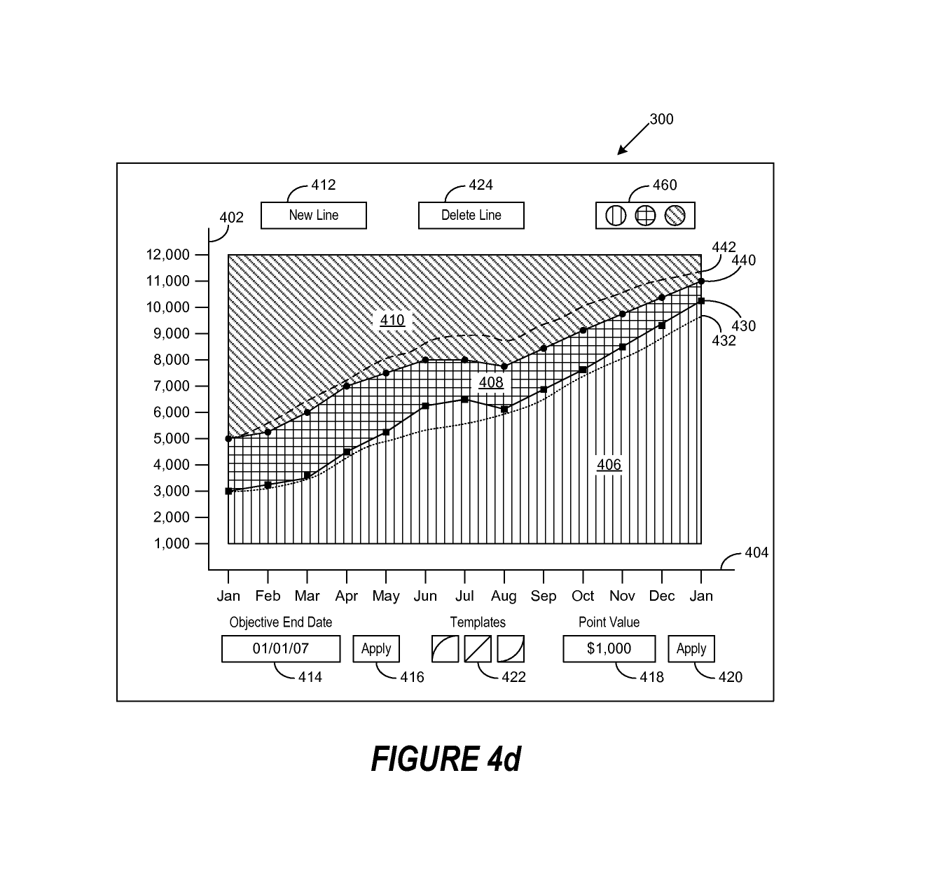

Application programs 144 in client computer 102's system memory also include performance monitor 148. Performance monitor 148 includes code for implementing the processes described in FIGS. 4a-d. In one embodiment, client computer 102 is able to download performance monitor 148 from service provider server 202.

The hardware elements depicted in client computer 102 are not intended to be exhaustive, but rather are representative to highlight essential components required by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

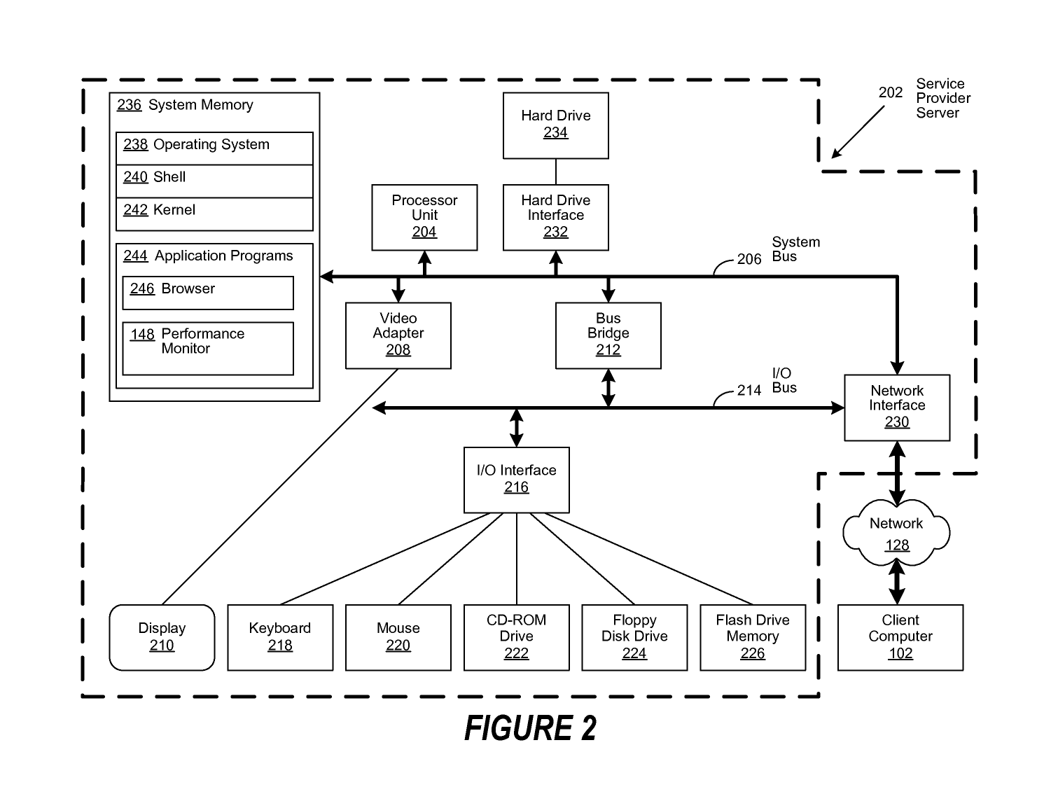

As noted above, performance monitor 148 can be downloaded to client computer 202 from service provider server 202, shown in exemplary form in FIG. 2. Service provider server 202 includes a processor unit 204 that is coupled to a system bus 206. A video adapter 208 is also coupled to system bus 206. Video adapter 208 drives/supports a display 210. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk—Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Service provider server 202 is able to communicate with client computer 102 via network 128 using a network interface 230, which is coupled to system bus 206. Access to network 128 allows service provider server 202 to execute and/or download performance monitor 148 to client computer 102.

System bus 206 is also coupled to a hard drive interface 232, which interfaces with a hard drive 234. In a preferred embodiment, hard drive 234 populates a system memory 236, which is also coupled to system bus 206. Data that populates system memory 236 includes service provider server 202's operating system 238, which includes a shell 240 and a kernel 242. Shell 240 is incorporated in a higher level operating system layer and utilized for providing transparent user access to resources such as application programs 244, which include a browser 246, and a copy of performance monitor 148 described above, which can be deployed to client computer 102.

The hardware elements depicted in service provider server 202 are not intended to be exhaustive, but rather are representative to highlight essential components required by the present invention. For instance, service provider server 202 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 202 performs all of the functions associated with the present invention (including execution of performance monitor 148), thus freeing client computer 102 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

FIG. 3 shows a generalized block diagram of a performance monitor as implemented in accordance with an embodiment of the present invention. Performance monitor 148 comprises Graphical User Interface (GUI) 300, performance algorithms 302, and configuration data 304. GUI 300 allows a user to graphically define an ultimate target with one or more performance thresholds as well as a plurality of intermediate milestone targets, each with one or more performance thresholds. Performance algorithms 302 comprise one or more computational algorithms operable to accept a measurement value with a corresponding time index, determine the corresponding target and performance thresholds for that same time index, and then formulate a performance status based on the relationship of the measurement to the computed target and performance thresholds.

As an example, an algorithm for determining performance status uses the time index of a measurement to first determine the two closest intermediate milestones. Next, the time index is used to interpolate an intermediate milestone target, which corresponds to the time index. This selection and interpolation process is repeated for each intermediate milestone threshold value. The result is a time indexed target value and one or more associated threshold values. The measurement can then be compared to these computed values to determine a performance status of the measurement.

Configuration data 304 includes, but is not limited to, saved data corresponding to ultimate targets and performance thresholds, zero or more intermediate milestone targets and milestone thresholds, and associated rules, policies and constraints, structured such that they can be accessed by GUI 300 and performance algorithms 302. The combination of an ultimate target and one or more performance thresholds, along with intermediate milestone targets and performance thresholds is referred to as a schedule, which can likewise be saved in configuration data 304 and accessed as needed. A plurality of schedules can be stored in configuration data 304, but only one schedule is associated with an ultimate target at any time.

FIGS. 4a-d show graphical depictions generated by the performance monitors to set performance milestones and monitor their achievement toward a target goal over a predetermined period of time. Progress towards a target objective, relative to one or more performance thresholds, is graphically depicted via the GUI 300. The GUI 300 is implemented for establishing intermediate milestones and ultimate targets, along with one or more performance thresholds for each. The GUI 300 likewise provides for the graphical manipulation of both intermediate and ultimate targets as well as their associated threshold values.

Performance monitor GUI 300 comprises user controls for creating a new performance threshold line 412, setting an end date for an objective 414, applying an objective end date 416, setting target or threshold point values 418, applying target or threshold point values 420, selecting predetermined performance threshold lines and/or threshold values from templates 422, deleting a performance threshold line 424, and assigning color values 460 to performance threshold lines and other graphically-displayed items.

Vertical axis 402 references target objective and performance threshold point values and horizontal axis 404 references time intervals, with lower performance threshold line 430 and upper performance threshold line 440 bounding graphically-depicted underachieving performance indicator 406, marginal performance indicator 408, and overachieving performance indicator 410. Graphically-depicted performance indicators may be color-coded to facilitate visual interpretation, such as using red for underachieving performance indicator 406, yellow for marginal performance indicator 408, and green for overachieving performance indicator 410.

Referring now to FIG. 4a, a linear progression depicts an example of intermediate, monthly milestone targets and performance thresholds with upper performance threshold line 440 depicting an ending target value of 11,000 and lower performance threshold line 430 depicting a lower performance threshold value of 9,000 for a fiscal year ending in the month of January. The interface allows manipulation of performance threshold lines 430, 440 in their entirety or by one or more points as shown in FIG. 4b. For example, template user control 422 is used to select a predefined progression curve for overachieving performance, which is then applied to the April through July time period resulting in a performance threshold line bump for those months. Likewise, performance threshold lines 430, 440 can be set to converge as the schedule progresses from August to the January end date. Similarly, individual performance threshold values for June and July may be modified by either entering threshold values for the selected points into point value field 418 and then using user control 420 to apply them, or by graphically selecting the points through user gestures and sliding them up or down within the user interface to effect their value. The same visual display is used to depict actual performance measurements 450 as illustrated in FIG. 4c.

Referring now to FIG. 4d, rules, policies and constraints are implemented such that boundary limits 432, 442 are graphically depicted for performance threshold lines 430, 440 respectively. In an embodiment of the invention, bounding information is graphically depicted by boundary limits 432, 434 through dynamic evaluation of existing points and rules, policies or constraints that might limit their values. In another embodiment of the invention, graphically depicted boundary limits 432, 434 similarly restrict the movement of individual intermediate points in either direction such that rules, policies or constraints that might limit their values are enforced. It will also be apparent to those of skill in the art that as one intermediate point is changed, associated boundary limits 432, 434 may be revised as determined by predetermined rules, policies and/or constraints.

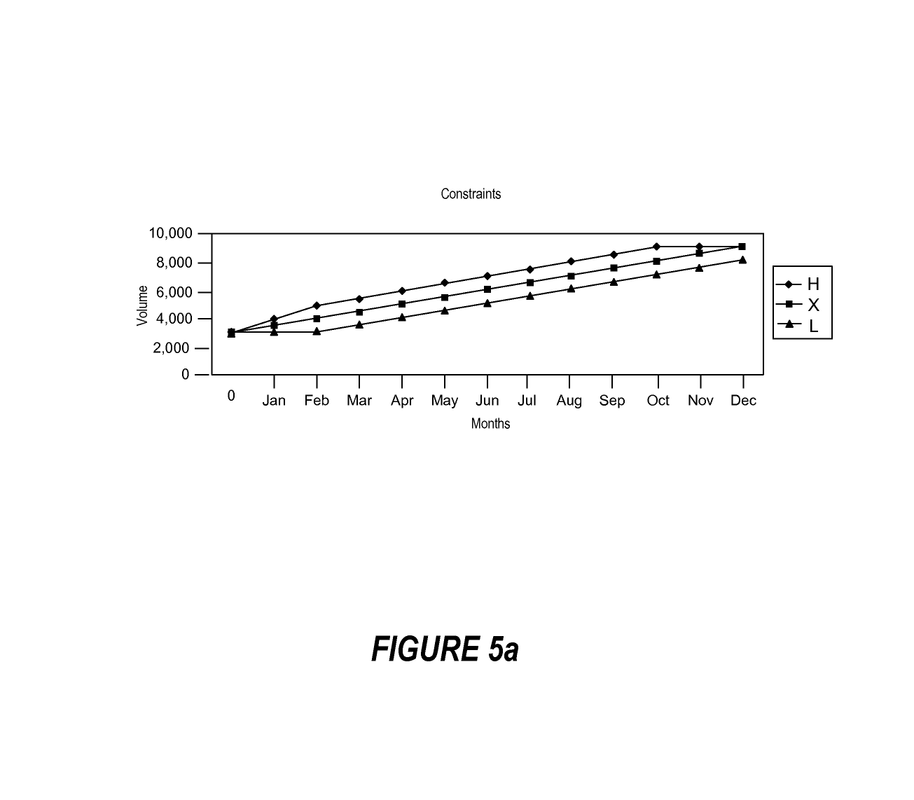

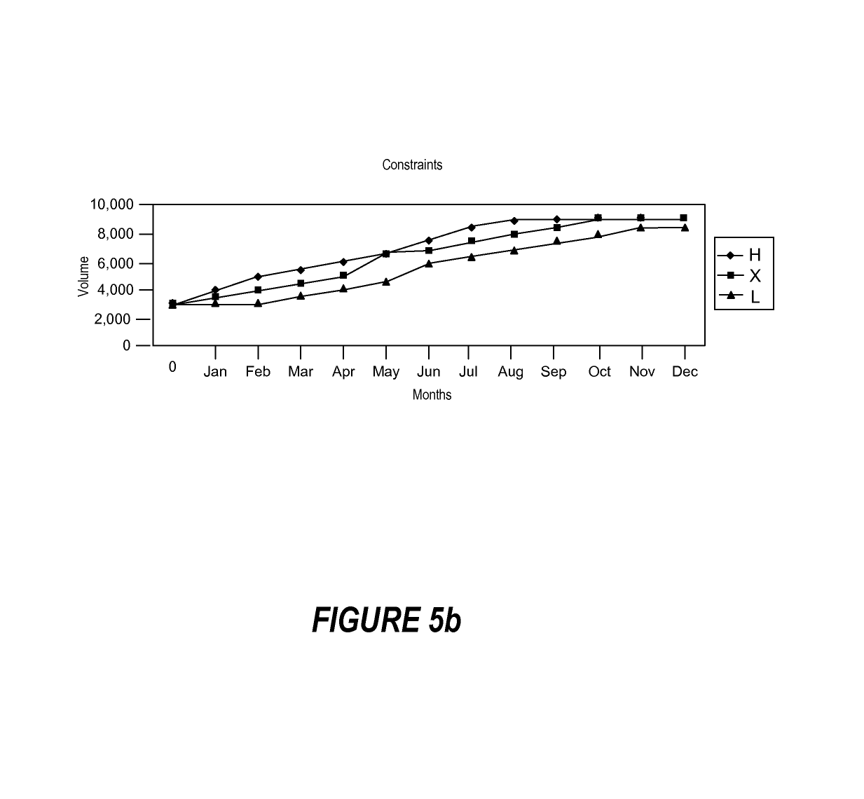

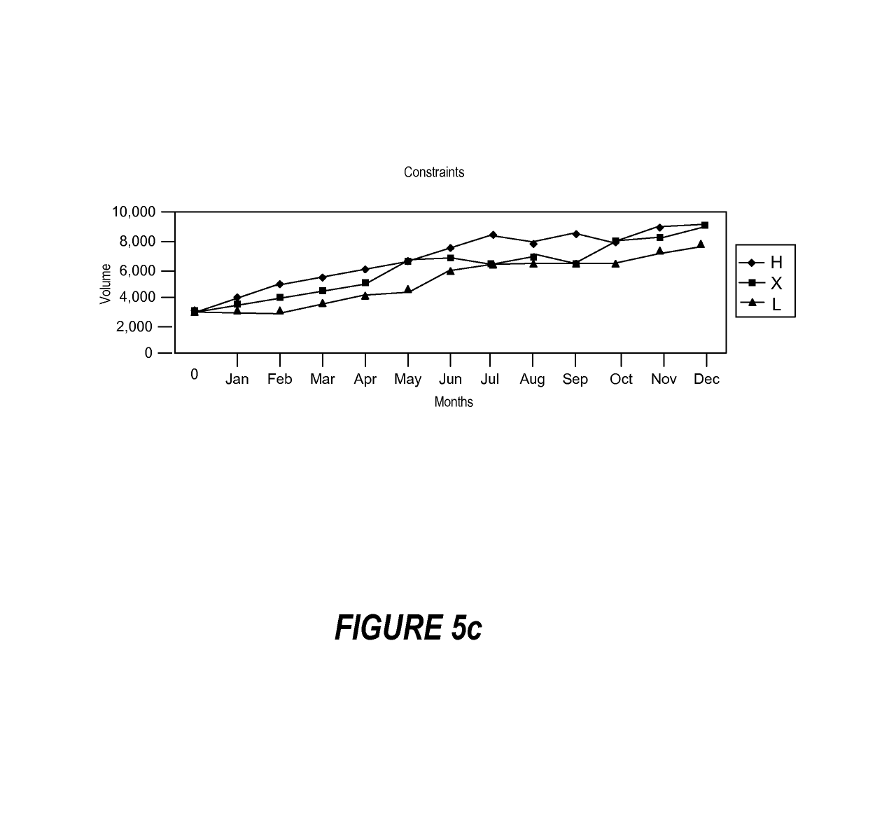

FIGS. 5a-c show graphical depictions generated by the performance monitors in an example of an instantiation of the invention using an example projection algorithm to set performance milestones and monitor their achievement toward a target goal over a predetermined period of time. Progress towards a target objective, relative to one or more performance thresholds is graphically depicted via the GUI 300. The GUI 300 is implemented for establishing intermediate milestones and ultimate targets, along with one or more performance thresholds for each. The GUI 300 likewise provides for the graphical manipulation of both intermediate and ultimate targets as well as their associated threshold values.

Performance monitor GUI 300 comprises user controls for creating a new performance threshold line 412, setting an end date for an objective 414, applying an objective end date 416, setting target or threshold point values 418, applying target or threshold point values 420, selecting predetermined performance threshold lines and/or threshold values from templates 422, deleting a performance threshold line 424, and assigning color values 460 to performance threshold lines and other graphically-displayed items. Vertical axis 402 references target objective and performance threshold point values and horizontal axis 404 references time intervals. Graphically-depicted performance indicators may be color-coded to facilitate visual interpretation, such as using green for overachieving performance threshold indicator ‘H’ 510, yellow for performance attainment indicator ‘X’ 508, and red for underachieving performance threshold indicator ‘L’ 506.

Referring now to FIG. 5a, a linear progression depicts an example of intermediate, monthly milestone targets with a beginning value of 3,000, incrementally increased by a value of 500 month-by-month, resulting in an ending target value of 9,000. The monthly values and respective graphic indicators of overachieving performance threshold ‘H’ 510 and underachieving performance threshold ‘L’ 506 are determined by applying the monthly value of performance attainment ‘X’ 508 to an algorithm such as:

High[n]=min(X[n−1]+1500, H[n−1]+1000,9000)

Low[n]=max(X[n−1]−500, L[n−1]−2000)

X[n]=X[n−1]+500

Implementation of the algorithm results in the graphical display of forecasted bounds for overachieving performance threshold ‘H’ 510 and underachieving performance threshold ‘L’ 506 to attain the year-end target value. Implementation of the algorithm also provides a graphical display depicting current and historical performance attainment against previously forecasted overachieving performance thresholds ‘H’ 510 and underachieving performance thresholds ‘L’ 506.

For example, FIG. 5b depicts historical performance attainment indicator ‘X’ 514 against previously forecasted overachieving performance thresholds ‘H’ 516 and underachieving performance thresholds ‘L’ 512 as of June and the forecasted performance attainment ‘X’ 508 required to achieve the end-of-year goal of 9,000, similarly bounded by overachieving performance thresholds ‘H’ 510 and underachieving performance thresholds ‘L’ 506. The same visual display is used to depict historical performance attainment indicator ‘X’ 514 against previously forecasted overachieving performance thresholds ‘H’ 516 and underachieving performance thresholds ‘L’ 512 to achieve the end-of-year goal of 9,000 as illustrated in FIG. 5c. As the value of performance attainment indicator ‘X’ 514 is changed month-by-month, a corresponding change occurs in the previously forecasted values represented by overachieving performance threshold indicator ‘H’ 516 and underachieving performance threshold indicator ‘L’ 512.

Thus, the method described herein and in particular as shown and described in FIGS. 4a-d, can be deployed as process software from service provider server 202 shown in FIG. 2 to client computer 102 shown in FIG. 1.

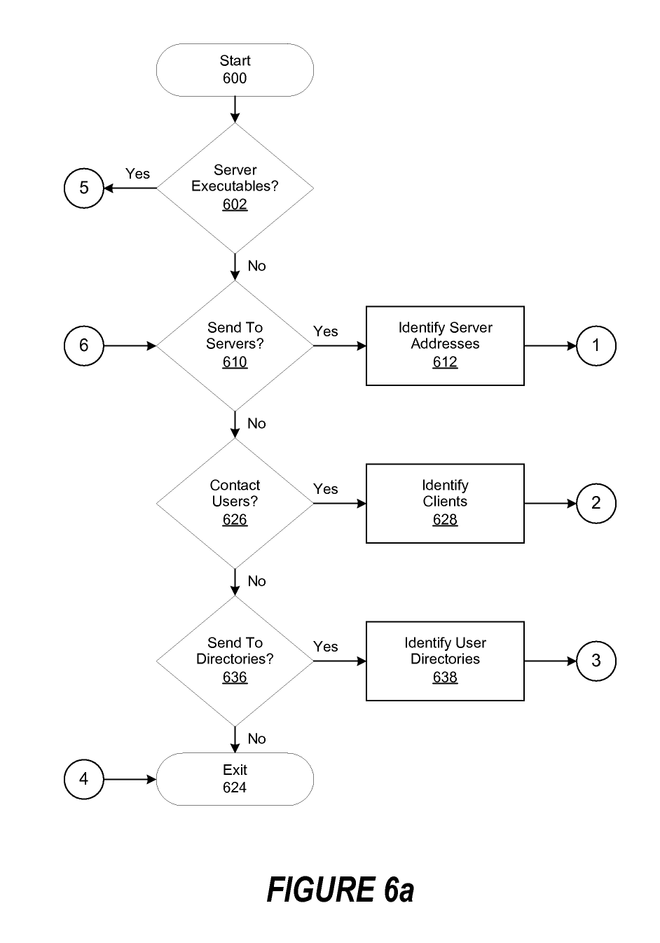

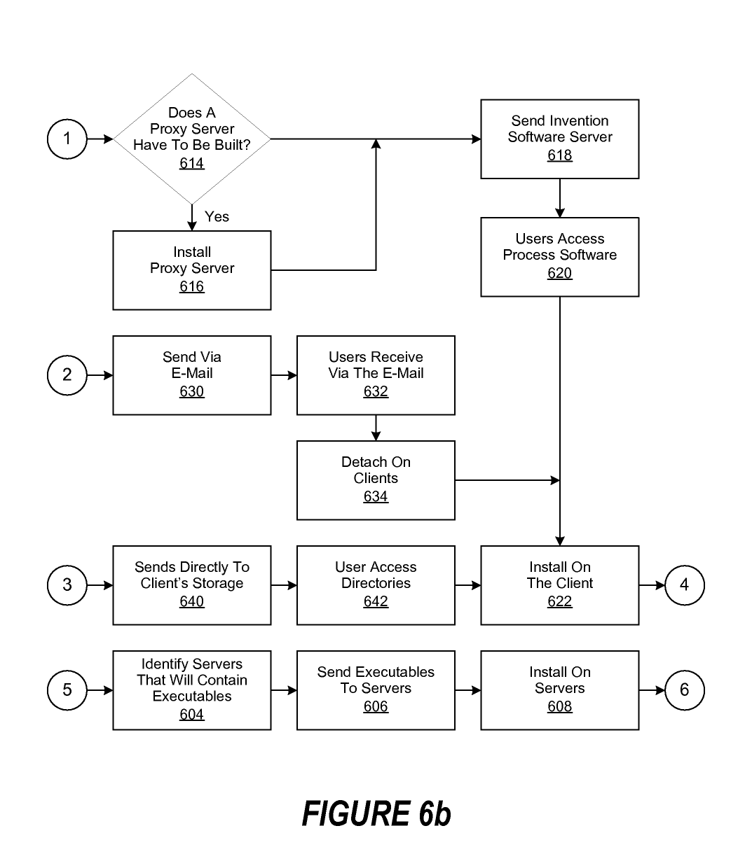

Referring then to FIG. 6, step 600 begins the deployment of the process software. The first thing is to determine if there are any programs that will reside on a server or servers when the process software is executed (query block 602). If this is the case, then the servers that will contain the executables are identified (block 604). The process software for the server or servers is transferred directly to the servers' storage via File Transfer Protocol (FTP) or some other protocol or by copying though the use of a shared file system (block 606). The process software is then installed on the servers (block 608).

Next, a determination is made on whether the process software is to be deployed by having users access the process software on a server or servers (query block 610). If the users are to access the process software on servers, then the server addresses that will store the process software are identified (block 612).

A determination is made if a proxy server is to be built (query block 614) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 616). The process software is sent to the servers either via a protocol such as FTP or it is copied directly from the source files to the server files via file sharing (block 618). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 620). Another embodiment is to have the servers automatically copy the process software to each client and then run the installation program for the process software at each client computer. The user executes the program that installs the process software on his client computer (block 622) then exits the process (terminator block 624).

In query step 626, a determination is made whether the process software is to be deployed by sending the process software to users via e-mail. The set of users where the process software will be deployed are identified together with the addresses of the user client computers (block 628). The process software is sent via e-mail to each of the users' client computers (block 630). The users then receive the e-mail (block 632) and then detach the process software from the e-mail to a directory on their client computers (block 634). The user executes the program that installs the process software on his client computer (block 622) then exits the process (terminator block 624).

Lastly a determination is made on whether to the process software will be sent directly to user directories on their client computers (query block 636). If so, the user directories are identified (block 638). The process software is transferred directly to the user's client computer directory (block 640). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 642). The user executes the program that installs the process software on his client computer (block 622) and then exits the process (terminator block 624).

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or un-trusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

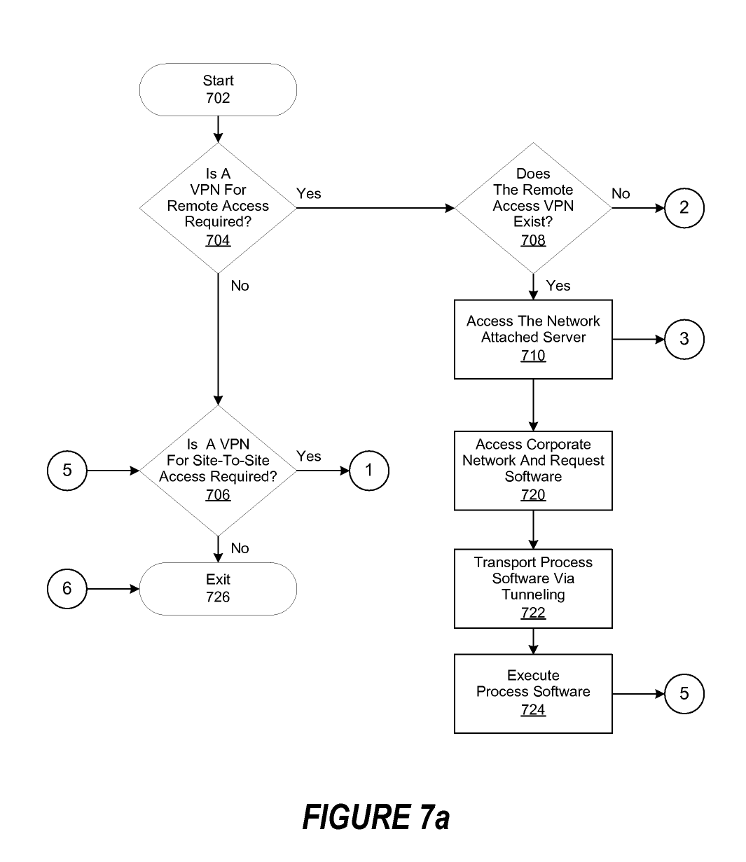

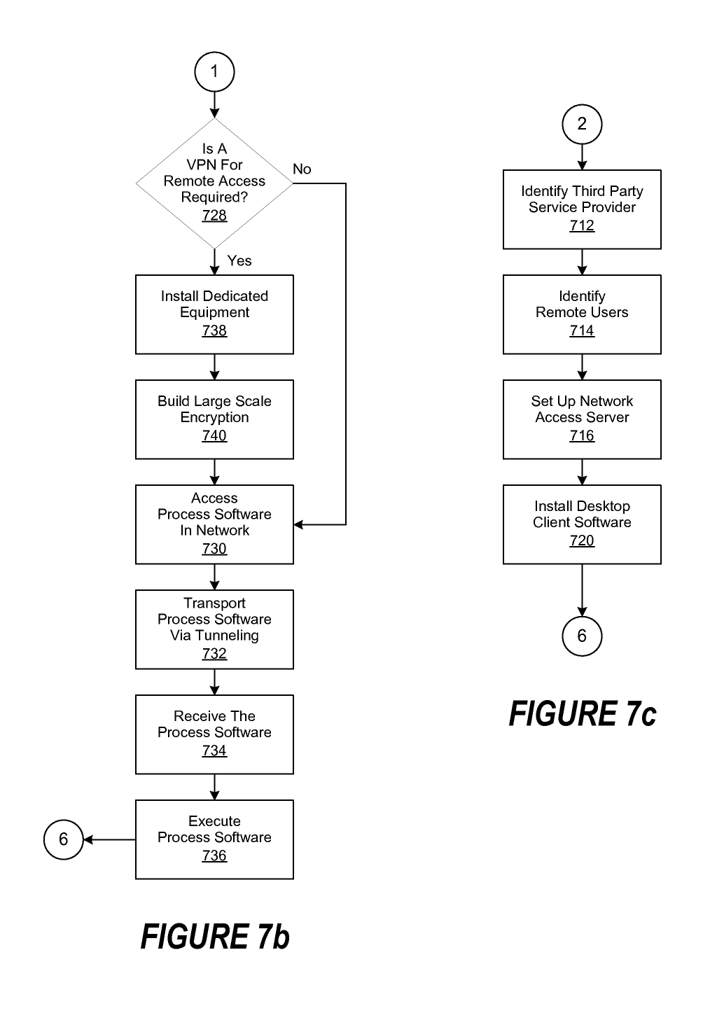

The process for such VPN deployment is described in FIG. 7. Initiator block 702 begins the Virtual Private Network (VPN) process. A determination is made to see if a VPN for remote access is required (query block 704). If it is not required, then proceed to query block 706. If it is required, then determine if the remote access VPN exists (query block 708).

If a VPN does exist, then proceed to block 710. Otherwise identify a third party provider that will provide the secure, encrypted connections between the company's private network and the company's remote users (block 712). The company's remote users are identified (block 714). The third party provider then sets up a network access server (NAS) (block 716) that allows the remote users to dial a toll free number or attach directly via a broadband modem to access, download and install the desktop client software for the remote-access VPN (block 718).

After the remote access VPN has been built or if it been previously installed, the remote users can access the process software by dialing into the NAS or attaching directly via a cable or DSL modem into the NAS (block 710). This allows entry into the corporate network where the process software is accessed (block 720). The process software is transported to the remote user's desktop over the network via tunneling. That is, the process software is divided into packets and each packet including the data and protocol is placed within another packet (block 722). When the process software arrives at the remote user's desktop, it is removed from the packets, reconstituted and then is executed on the remote user's desktop (block 724).

A determination is then made to see if a VPN for site to site access is required (query block 706). If it is not required, then proceed to exit the process (terminator block 726). Otherwise, determine if the site to site VPN exists (query block 728). If it does not exist, then proceed to block 730. Otherwise, install the dedicated equipment required to establish a site to site VPN (block 738). Then build the large scale encryption into the VPN (block 740).

After the site to site VPN has been built or if it had been previously established, the users access the process software via the VPN (block 730). The process software is transported to the site users over the network via tunneling (block 732). That is the process software is divided into packets and each packet including the data and protocol is placed within another packet (block 734). When the process software arrives at the remote user's desktop, it is removed from the packets, reconstituted and is executed on the site user's desktop (block 736). The process then ends at terminator block 726.

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

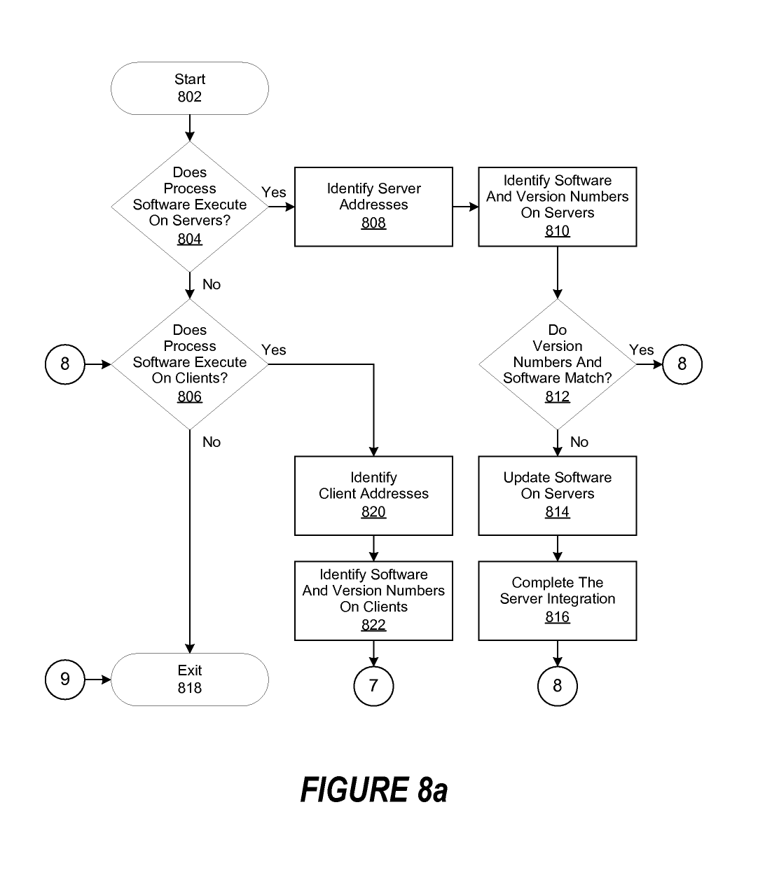

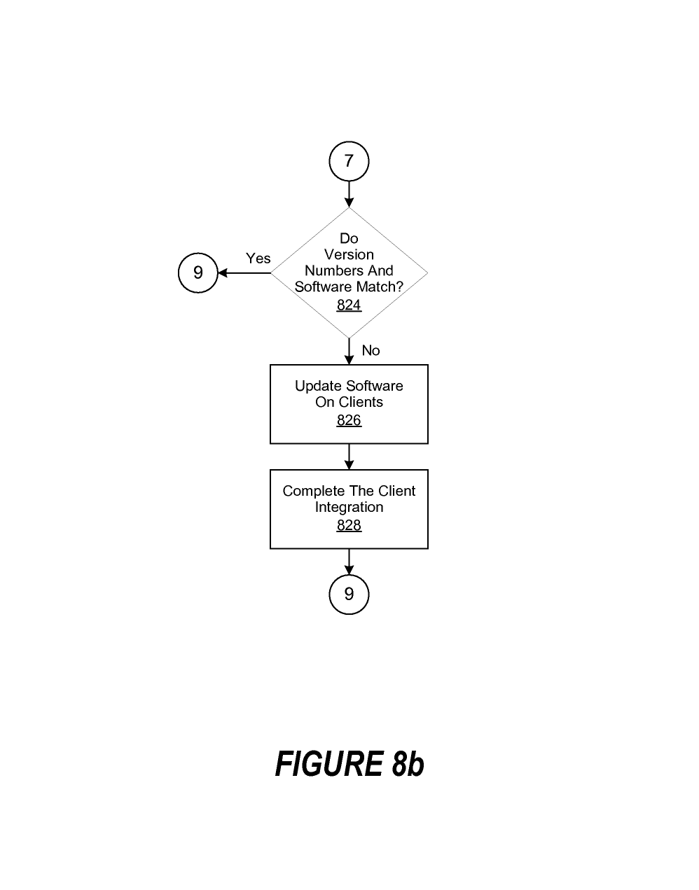

For a high-level description of this process, reference is now made to FIG. 8. Initiator block 802 begins the integration of the process software. The first tiling is to determine if there are any process software programs that will execute on a server or servers (block 8). If this is not the case, then integration proceeds to query block 806. If this is the case, then the server addresses are identified (block 808). The servers are checked to see if they contain software that includes the operating system (OS), applications, and network operating systems (NOS), together with their version numbers, which have been tested with the process software (block 810). The servers are also checked to determine if there is any missing software that is required by the process software in block 810.

A determination is made if the version numbers match the version numbers of OS, applications and NOS that have been tested with the process software (block 812). If all of the versions match and there is no missing required software the integration continues in query block 806.

If one or more of the version numbers do not match, then the unmatched versions are updated on the server or servers with the correct versions (block 814). Additionally, if there is required software missing, then it is updated on the server or servers in the step shown in block 814. The server integration is completed by installing the process software (block 816).

The step shown in query block 806, which follows either the steps shown in block 804, 812 or 816, determines if there are any programs of the process software that will execute on the clients. If no process software programs execute on the clients the integration proceeds to terminator block 818 and exits. If this not the case, then the client addresses are identified as shown in block 820.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 822.

A determination is made is the version numbers match the version numbers of OS, applications and NOS that have been tested with the process software (query block 824). If all of the versions match and there is no missing required software, then the integration proceeds to terminator block 818 and exits.

If one or more of the version numbers do not match, then the unmatched versions are updated on the clients with the correct versions (block 826). In addition, if there is missing required software then it is updated on the clients (also block 826). The client integration is completed by installing the process software on the clients (block 828). The integration proceeds to terminator block 818 and exits.

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

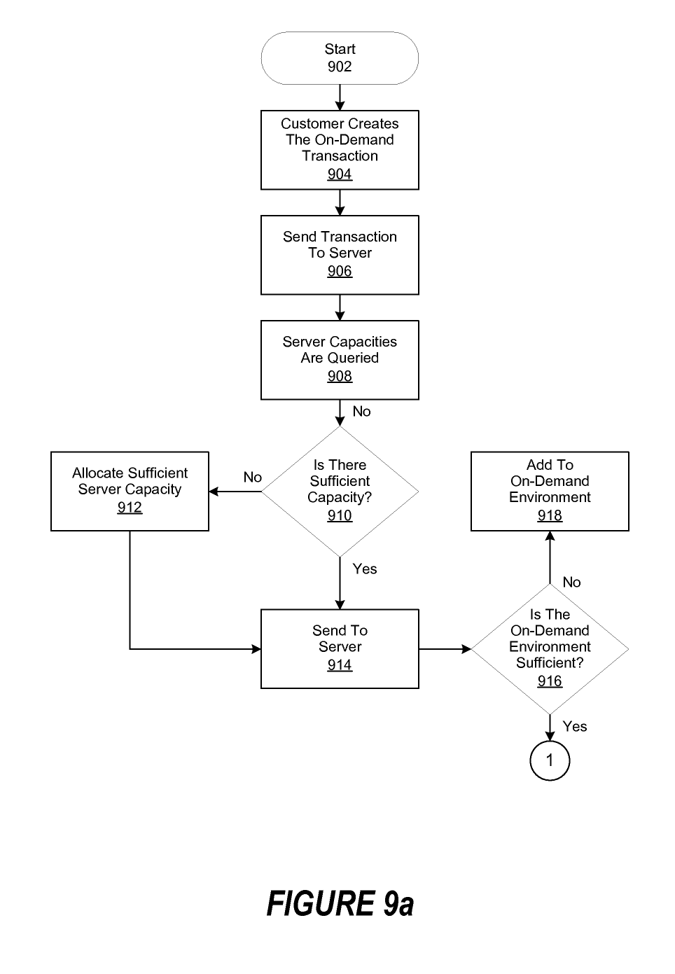

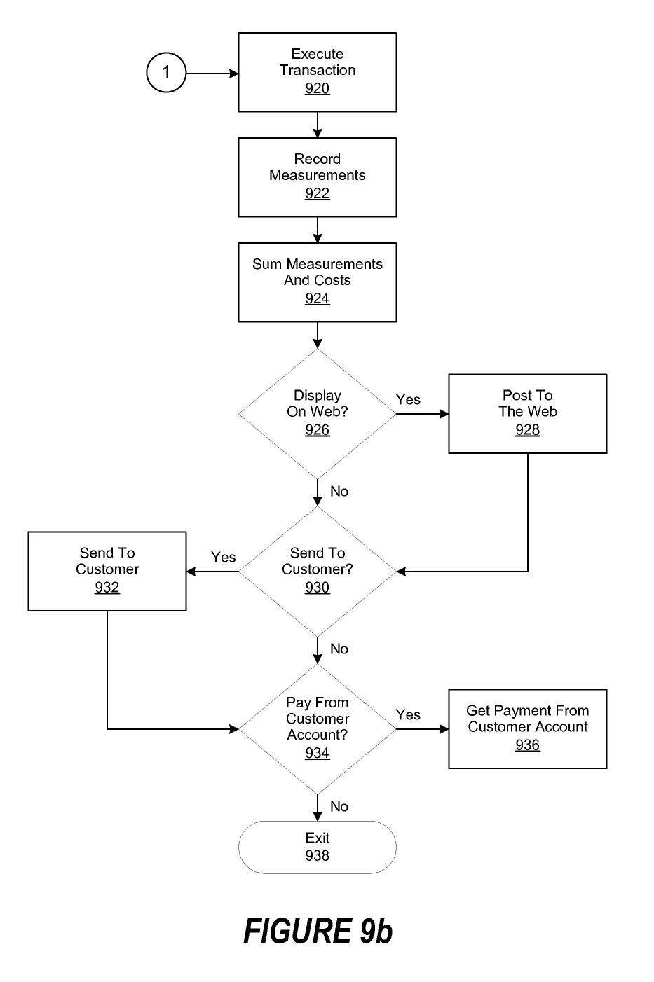

With reference now to FIG. 9, initiator block 902 begins the On Demand process. A transaction is created that contains the unique customer identification, the requested service type and any service parameters that further, specify the type of service (block 904). The transaction is then sent to the main server (block 906). In an On Demand environment the main server can initially be the only server, and then as capacity is consumed other servers are added to the On Demand environment.

The server central processing unit (CPU) capacities in the On Demand environment are queried (block 908). The CPU requirement of the transaction is estimated, then the servers available CPU capacity in the On Demand environment are compared to the transaction CPU requirement to see if there is sufficient CPU available capacity in any server to process the transaction (query block 910). If there is not sufficient server CPU available capacity, then additional server CPU capacity is allocated to process the transaction (block 912). If there was already sufficient available CPU capacity then the transaction is sent to a selected server (block 914).

Before executing the transaction, a check is made of the remaining On Demand environment to determine if the environment has sufficient available capacity for processing the transaction. This environment capacity consists of such things as but not limited to network bandwidth, processor memory, storage etc. (block 916). If there is not sufficient available capacity, then capacity will be added to the On Demand environment (block 918). Next the required software to process the transaction is accessed, loaded into memory, and then the transaction is executed (block 920).

The usage measurements are recorded (block 922). The usage measurements consist of the portions of those functions in the On Demand environments that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 924).

If the customer has requested that the On Demand costs be posted to a web site (query block 926), then they are posted (block 928). If the customer has requested that the On Demand costs be sent via e-mail to a customer address (query block 930), then these costs are sent to the customer (block 932). If the customer has requested that the On Demand costs be paid directly from a customer account (query block 934), then payment is received directly from the customer account (block 936). The On Demand process is then exited at terminator block 938.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

Also for example, while the preferred embodiment sets forth an example use of the performance monitor 148 as modeling of business or financial goals, it will be appreciated that other uses of the performance monitor 148 are also contemplated. For example, the performance monitor 148 may be used for computing application capacity/performance planning (such as Application/Database/Web Server deployments), manufacturing and/or production modeling, and general supply/demand relationship planning as well as any other performance monitor uses.

What is claimed is:

1. A computer-implementable method comprising:
receiving performance milestones via a graphical user interface; and,
monitoring achievement of the performance milestones toward a target goal through a graphical user interface (GUI), the monitoring achievement of the performance milestones including editing intermediate performance milestone values via the GUI by applying configuration data that operate with performance algorithms to more accurately define expected performance over a predetermined time period.

2. The computer-implementable method of claim 1 wherein:
the monitoring achievement of the performance milestones includes defining and bounding dependencies associated with the intermediate performance milestones.

3. The computer-implementable method of claim 1 wherein:
the monitoring achievement of the performance milestones includes showing boundary information, the boundary information defining movement limits of intermediate points within a graph.

4. The computer-implementable method of claim 3 wherein:
movement limits of predetermined intermediate points can be set in either direction based on dynamic evaluation of existing points and associated rules, policies, and constraints.

5. The computer-implementable method of claim 1 wherein:
the performance algorithms accept a measurement value with a corresponding time index to determine corresponding target and performance thresholds for that same time index and then formulate a performance status based on the relationship of the measurement to the computed target and performance thresholds.

6. The computer-implementable method of claim 1 wherein:
the configuration data includes saved data corresponding to ultimate targets and performance thresholds and zero or more intermediate milestone targets and milestone thresholds, and associated rules, policies and constraints; and,
an ultimate target and one or more performance thresholds, along with intermediate milestone targets and performance thresholds is a schedule, the schedule being saved as configuration data.

7. A system comprising:
a processor;
a data bus coupled to the processor; and
a computer-usable medium embodying computer program code, the computer-usable medium being coupled to the data bus, the computer program code comprising instructions executable by the processor and configured for:
receiving performance milestones via a graphical user interface; and,
monitoring achievement of the performance milestones toward a target goal through a graphical user interface (GUI), the monitoring achievement of the performance milestones including editing intermediate performance milestone values via the GUI by applying configuration data that operate with performance algorithms to more accurately define expected performance over a predetermined time period.

8. The system of claim 7, wherein the instructions are further configured for:
defining and bounding dependencies associated with the intermediate performance milestones.

9. The system of claim 7, wherein:
the monitoring achievement of the performance milestones includes showing boundary information, the boundary information defining movement limits of intermediate points within a graph.

10. The system of claim 7, wherein:
movement limits of predetermined intermediate points can be set in either direction based on dynamic evaluation of existing points and associated rules, policies, and constraints.

11. The system of claim 7, wherein:
the performance algorithms accept a measurement value with a corresponding time index to determine corresponding target and performance thresholds for that same time index and then formulate a performance status based on the relationship of the measurement to the computed target and performance thresholds.

12. The system of claim 7, wherein:
the configuration data includes saved data corresponding to ultimate targets and performance thresholds and zero or more intermediate milestone targets and milestone thresholds, and associated rules, policies and constraints; and,
an ultimate target and one or more performance thresholds, along with intermediate milestone targets and performance thresholds is a schedule, the schedule being saved as configuration data.

13. A computer-usable medium embodying computer program code, the
computer program code comprising computer executable instructions configured for:
receiving performance milestones via a graphical user interface; and,
monitoring achievement of the performance milestones toward a target goal through a graphical user interface (GUI), the monitoring achievement of the performance milestones including editing intermediate performance milestone values via the GUI by applying configuration data that operate with performance algorithms to more accurately define expected performance over a predetermined time period.

14. The computer-usable medium of claim 13, wherein the embodied computer program code further comprises computer executable instructions configured for:
defining and bounding dependencies associated with the intermediate performance milestones.

15. The computer-usable medium of claim 13, wherein:
the monitoring achievement of the performance milestones includes showing boundary information, the boundary information defining movement limits of intermediate points within a graph.

16. The computer-usable medium of claim 13, wherein:
movement limits of predetermined intermediate points can be set in either direction based on dynamic evaluation of existing points and associated rules, policies, and constraints.

17. The computer-usable medium of claim 13, wherein:
the performance algorithms accept a measurement value with a corresponding time index to determine corresponding target and performance thresholds for that same time index and then formulate a performance status based on the relationship of the measurement to the computed target and performance thresholds.

18. The computer-usable medium of claim 13, wherein:
the configuration data includes saved data corresponding to ultimate targets and performance thresholds and zero or more intermediate milestone targets and milestone thresholds, and associated rules, policies and constraints; and,
an ultimate target and one or more performance thresholds, along with intermediate milestone targets and performance thresholds is a schedule, the schedule being saved as configuration data.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
